(19) United States
(12) Patent Application Publication
(10) Pub. No.: US 2014/0181567 A1
(43) Pub. Date: Jun. 26, 2014

(54) COMMAND CONTROL CIRCUIT FOR MEMORY DEVICE AND MEMORY DEVICE INCLUDING THE SAME

(71) Applicant: Samsung Electronics Co., Ltd., Suwon-si (KR)

(72) Inventors: Hun-Dae CHOI, Seoul (KR); In-Dal SONG, Seoul (KR)

(73) Assignee: Samsung Electronics Co., Ltd., Suwon-si (KR)

(21) Appl. No.: 14/097,689

(22) Filed: Dec. 5, 2013

(30) Foreign Application Priority Data
Dec. 21, 2012 (KR) 10-2012-0150872

(51) Int. Cl. G06F 1/12

(52) U.S. Cl. CPC G06F 1/12
USPC 713/400

(57) ABSTRACT

Exemplary embodiments disclose a command control circuit including a command decoder configured to generate an internal command signal using a chip select (CS) signal and a command signal, and a CS gating logic configured to provide the CS signal to the command decoder, wherein the CS gating logic is further configured to provide the CS signal to the command decoder in response to a clock enable (CKE) signal being at a first level, and block the CS signal from the command decoder in response to the CKE signal being at a second level.

This application claims priority from Korean Patent Application No. 10-2012-0150872 filed on Dec. 21, 2012 in the Korean Intellectual Property Office, the disclosure of which is incorporated herein by reference in its entirety.

### BACKGROUND

1. Field

Exemplary embodiments relate to a command control circuit for a memory device and a memory device including the same.

2. Description of the Related Art

Volatile memories may be divided into dynamic random access memories (DRAMs) and static random access memories (SRAMs). Unlike SRAMS, DRAMs operate at low speed. However, since DRAMs consume low power and are inexpensive, they are usually used in high-capacity storage devices. DRAMs can be divided into asynchronous DRAMs, such as a first page mode (FPM) DRAMs and an extended data out (EDO) DRAMs, and synchronous DRAMs (SDRAMs), such as a single data rate (SDR) SDRAMs, a double data rate (DDR) SDRAMs, a graphic DDR (GDDR) SDRAMs, a reduced latency DRAMs (RLDRAMs), a direct rambus DRAMs (RDRAMs), and an extreme data rate (XDR) DRAMs.

In a power-down mode of the related art, a memory device can prevent a command decoder from generating an invalid command by gating a clock signal. Gating the clock signal occurs using a clock enable signal. However, in a high-speed memory device, a glitch may occur.

### SUMMARY

Aspects of the exemplary embodiments may provide a command control circuit for a memory device, and when a memory device is in a power-down mode, the command control circuit is capable of preventing an invalid command from being generated by a glitch.

Aspects of the exemplary embodiments may also provide a memory device which, when the memory device is in a power-down mode, can prevent an invalid command from being generated by a glitch.

However, aspects of the exemplary embodiments are not restricted. The above and other aspects of the exemplary embodiments will become more apparent to one of ordinary skill in the art to which the exemplary embodiments pertains by referencing the detailed description given below.

According to an aspect of the exemplary embodiments, there is provided a command control circuit including a command decoder configured to generate an internal command signal using a chip select (CS) signal and a command signal, and a CS gating logic configured to provide the CS signal to the command decoder, wherein the CS gating logic is further configured to provide the CS signal to the command decoder in response to a clock enable (CKE) signal being at a first level, and block the CS signal from reaching the command decoder in response to the CKE signal being at a second level.

According to another aspect of the exemplary embodiments, there is provided a command control circuit including a command decoder configured to generate an internal command signal, and a CS gating logic configured to gate a CS signal using a CKE signal and providing the gated CS signal to the command decoder, wherein the command decoder is enabled in response to the gated CS signal being at a first level, and is disabled in response to the gated CS signal being at a second level.

According to another aspect of the exemplary embodiments, there is provided a method of a command control circuit including receiving a chip select (CS) signal, a command signal, and a clock enable (CKE) signal, generating an internal command signal based on the CS signal and the command signal in response to the CKE signal being at a first level, and blocking the internal command signal from being generated in response to the CKE signal being at a second level.

### BRIEF DESCRIPTION OF THE DRAWINGS

The above and other aspects and features of the exemplary embodiments will become more apparent by describing in detail exemplary embodiments thereof with reference to the attached drawings, in which:

FIG. 1 is a schematic block diagram of a command control circuit for a memory device according to a first embodiment;

FIG. 2 is a schematic timing diagram illustrating changes in some signals in the command control circuit of FIG. 1;

FIG. 3 is a schematic block diagram of a command control circuit for a memory device according to a second embodiment;

FIG. 4 is a schematic timing diagram illustrating changes in some signals in the command control circuit of FIG. 3;

FIG. 5 is a schematic block diagram of a command control circuit for a memory device according to a third embodiment;

FIG. 6 is a schematic timing diagram illustrating changes in some signals in the command control circuit of FIG. 5;

FIG. 7 is a schematic block diagram of a memory device including a command control circuit according to some embodiments;

FIG. 8 is a schematic block diagram of an electronic system including a memory device according to an embodiment; and

FIG. 9 is a schematic block diagram of an application example of the electronic system including a memory device according to an embodiment.

### DETAILED DESCRIPTION OF THE EXEMPLARY EMBODIMENTS

The exemplary embodiments will now be described more fully hereinafter with reference to the accompanying drawings, in which preferred embodiments of the exemplary embodiments are shown. The exemplary embodiments may, however, be embodied in different forms and should not be construed as limited to the embodiments set forth herein. Rather, these embodiments are provided so that this disclosure will be thorough and complete, and will filly convey the scope of the exemplary embodiments to those skilled in the art. The same reference numbers indicate the same components throughout the specification. In the attached figures, the thickness of layers and regions is exaggerated for clarity.

It will also be understood that when a layer is referred to as being “on” another layer or substrate, it can be directly on the other layer or substrate, or intervening layers may also be present. In contrast, when an element is referred to as being “directly on” another element, there are no intervening elements present.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The use of the terms “a” and “an” and “the” and similar referents in the context of describing the exemplary embodiments (especially in the context of the following claims) are to be construed to cover both the singular and the plural, unless otherwise indicated herein or clearly contradicted by the context. The terms “comprising,” “having,” “including,” and “containing” are to be construed as open-ended terms (i.e., meaning “including, but not limited to,”) unless otherwise noted.

Unless defined otherwise, all technical and scientific terms used herein have the same meaning as commonly understood by one of ordinary skill in the art to which these exemplary embodiments belong. It is noted that the use of any and all examples, or exemplary terms provided herein is intended merely to better illuminate the exemplary embodiments, and is not a limitation on the scope of the exemplary embodiments unless otherwise specified. Further, unless defined otherwise, all terms defined in generally used dictionaries may not be overly interpreted.

The exemplary embodiments will be described with reference to perspective views, cross-sectional views, and/or plan views, in which preferred embodiments are shown. Thus, the profile of an exemplary view may be modified according to manufacturing techniques and/or allowances. In other words, the embodiments are not intended to limit the scope of the exemplary embodiments, but cover all changes and modifications that can be caused due to a change in manufacturing process. Thus, regions shown in the drawings are illustrated in schematic form and the shapes of the regions are presented simply by way of illustration, and not as a limitation.

Exemplary embodiments will hereinafter be described using a double data rate 3 synchronous dynamic random access memory (DDR3 SDRAM). However, it will be obvious to those of ordinary skill in the art to which the exemplary embodiments pertain that the exemplary embodiments is also applicable to other dynamic random access memories (DRAMs) such as a DDR2 SDRAM.

While not in use, a memory device may have several modes to reduce power consumption. For example, a power-down mode may indicate a low-power state, in which a memory device is maintained while not being accessed. For example, when a clock enable signal is maintained low for a certain period of time, the memory device may enter the power-down mode. In the power-down mode, a command decoder may be controlled to not generate an internal command signal.

A related art memory device enters the power-down mode by preventing a command signal from being input to a command decoder and blocking a clock signal using a clock enable signal. However, in a high-speed memory device of the related art, a glitch may occur because the clock signal is blocked abnormally. In addition, an invalid command may be generated by a command decoder. Therefore, the memory device of the related art may malfunction.

As will be described later, when a high-speed memory device is in the power-down mode, the exemplary embodiments use a CS gating logic, which gates a CS signal using a CKE signal, in order to prevent an invalid command from being generated by a glitch. The CS gating logic selectively provides the CS signal to a command decoder. Therefore, the command decoder is prevented from generating an invalid command. Further, the memory device is prevented from malfunctioning.

Exemplary embodiments will now be described in detail with reference to the attached drawings.

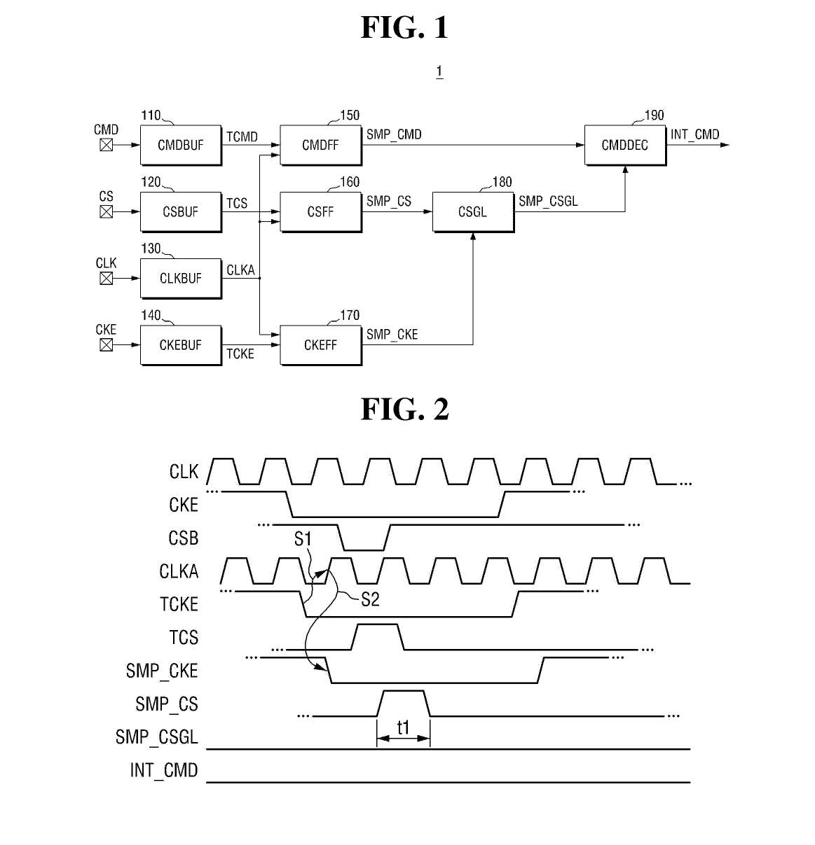

FIG. 1 is a schematic block diagram of a command control circuit 1 for a memory device according to a first embodiment.

Referring to FIG. 1, the command control circuit 1 for a memory device according to the first embodiment includes a command buffer (CMDBUF) 110, a CS buffer (CSBUF) 120, a clock buffer (CLKBUF) 130, a CKE buffer (CKEBUF) 140, a command flip-flop (CMDFF) 150, a CS flip-flop (CSFF) 160, a CKE flip-flop (CKEFF) 170, a CS gating logic (CSGL) 180, and a command decoder (CMDDEC) 190.

The CMDBUF 110 receives a command (CMD) signal at a TTL level from an external system and converts the CMD signal at the TTL level into a command (TCMD) signal at a CMOS level.

The CSBUF 120 receives a chip select (CS) signal at the TTL level from the external system and converts the CS signal at the TTL level into a chip select (TCS) signal at the CMOS level.

The CLKBUF 130 receives a clock (CLK) signal at the TTL level from the external system and converts the CLK signal at the TTL level into an internal clock (CLKA) signal at the CMOS level.

The CKEBUF 140 receives a clock enable (CKE) signal at the TTL level from the external system and converts the CKE signal at the TTL level into a clock enable (TCKE) signal at the CMOS level.

The CMDFF 150 receives the CLKA signal from the CLKBUF 130 and generates a synchronized command (SMP_CMD) signal by synchronizing the TCMD signal received from the CMDBUF 110 with the CLKA signal.

The CSFF 160 receives the CLKA signal from the CLKBUF 130 and generates a synchronized chip select (SMP_CS) signal by synchronizing the TCS signal received from the CSBUF 120 with the CLKA signal.

The CKEFF 170 receives the CLKA signal from the CLKBUF 130 and generates a synchronized clock enable (SMP_CKE) signal by synchronizing the TCKE signal received from the CKEBUF 140 with the CLKA signal.

The CSGL 180 gates the SMP_CS signal received from the CSFF 160 using the SMP_CKE signal received from the CKEFF 170. The CSGL 180 provides a SMP_CSGL signal, which is a result of gating the SMP_CS signal, to the CMDDEC 190.

The CMDDEC 190 generates an internal command (INT_CMD) signal using the SMP_CSGL signal received from the CSGL 180 and the SMP_CMD signal received from the CMDFF 150. For example, when the SMP_CSGL signal is at a first level (e.g., a high level), the CMDDEC 190 may be enabled. When the SMP_CSGL signal is at a second level (e.g., a low level), the CMDDEC 190 may be disabled. When enabled, the CMDDEC 190 may generate the INT_CMD signal. When disabled, the CMDDEC 190 may not generate the INT_CMD signal.

In the command control circuit 1 according to the first embodiment, in a normal mode, e.g., when the SMP_CKE signal is at the first level (e.g., the high level), the CSGL 180 provides the SMP_CS signal to the CMDDEC 190 without gating the SMP_CS signal. Accordingly, if the SMP_CS signal is at the first level (e.g., the high level), the SMP_CSGL signal becomes the first level, and the CMDDEC 190 is enabled to generate the INT_CMD signal.

On the other hand, in a power-down mode, for example, when the SMP_CKE signal is at the second level (e.g., the low level), the CSGL 180 blocks the SMP_CS signal from reaching the CMDDEC 190 by gating the SMP_CS signal. Accordingly, even if the SMP_CS signal is at the first level (e.g., the high level), the SMP_CSGL signal becomes the second level (e.g., the low level), and the CMDDEC 190 is disabled to not generate the INT_CMD signal.

In the command control circuit 1 according to the first embodiment, the SMP_CS signal is gated using the SMP_CKE signal. Therefore, a glitch does not occur, and the CMDDEC 190 can be prevented from generating an invalid command.

Simulation results of the command control circuit 1 shown in FIG. 1 will now be described. FIG. 2 is a schematic timing diagram illustrating changes in some signals in the command control circuit 1 of FIG. 1. In FIG. 2, a CSB signal is an inverted signal of a CS signal.

Referring to FIG. 2, a CLK signal is toggled periodically, and the CSB signal is input at a certain point in time. As a memory device enters the power-down mode, a CKE signal is maintained low for a certain period of time.

The CLKBUF 130 outputs the CLKA signal by delaying the CLK signal, and the CKEBUF 140 outputs the TCKE signal by delaying the CKE signal. The CKEFF 170 synchronizes the TCKE signal with the CLKA signal and outputs the SMP_CKE signal synchronized with the CLKA signal (s1 and s2). The CSBUF 120 outputs the TCS signal by inverting and delaying the CSB signal. The CSFF 160 synchronizes the TCS signal with the CLKA signal and outputs the SMP_CS signal synchronized with the CLKA signal.

In a section of t1, the SMP_CS signal is high, but the SMP_CKE signal is maintained low. Therefore, the SMP_CS signal is blocked by the CSGL 180. Thus, the SMP_CSGL signal is maintained low and not changed. Since the SMP_CSGL signal is maintained low, the CMDDEC 190 does not generate the INT_CMD signal.

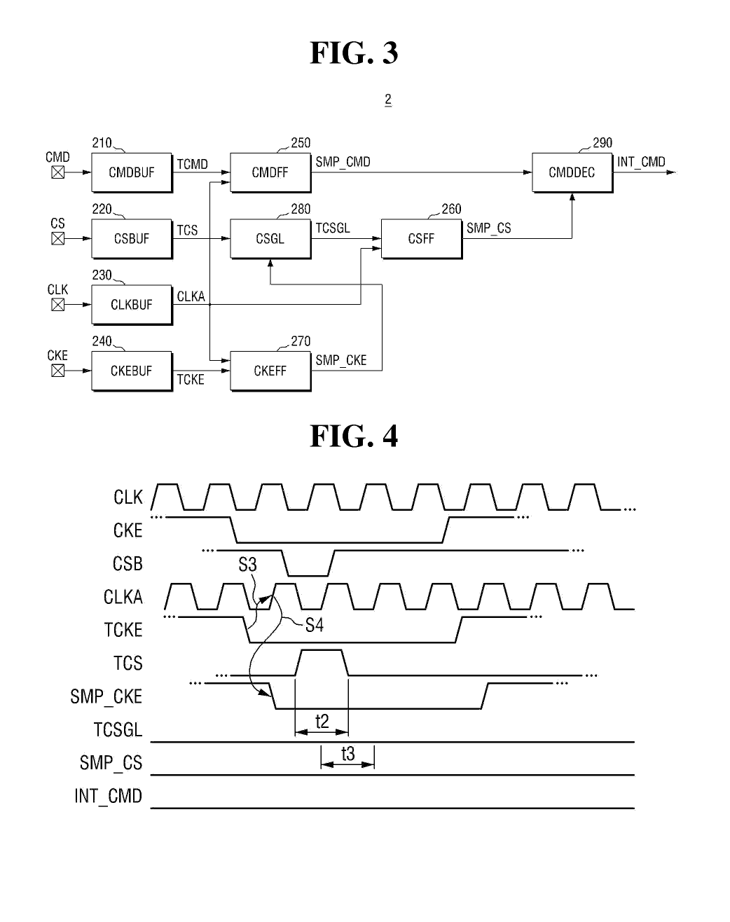

FIG. 3 is a schematic block diagram of a command control circuit 2 for a memory device according to a second embodiment. For simplicity, the following description will focus on differences from FIG. 1.

Referring to FIG. 3, in the command control circuit 2 for a memory device according to the second embodiment, a CSGL 280 gates a TCS signal received from a CSBUF 220 using a SMP_CKE signal received from a CKEFF 270. The CSGL 280 provides a TCSGL signal, which is a result of gating the TCS signal, to a CMDDEC 290.

A CSFF 260 is placed between the CSGL 280 and the CMDDEC 290. The CSFF 260 receives a CLKA signal from a CLKBUF 230, synchronizes the TCSGL signal received from the CSGL 280 with the CLKA signal, and provides a SMP_CS signal synchronized with the CLKA signal to the CMDDEC 290.

The CMDDEC 290 generates an internal command (INT_CMD) signal using the SMP_CS signal received from the CSFF 260 and a SMP_CMD signal received from a CMDFF 250. For example, when the SMP_CS signal is at a first level (e.g., a high level), the CMDDEC 290 may be enabled. When the SMP_CS signal is at a second level (e.g., a low level), the CMDDEC 290 may be disabled. When enabled, the CMDDEC 290 may generate the INT_CMD signal. When disabled, the CMDDEC 290 may not generate the INT_CMD signal.

In the command control circuit 2 according to the second embodiment, in a normal mode, e.g., when the SMP_CKE signal is at the first level (e.g., the high level), the CSGL 280 provides the TCS signal to the CMDDEC 290 without gating the TCS signal. Accordingly, if the TCS signal is at the first level (e.g., the high level), the TCSGL signal becomes the first level, and the SMP_CS signal synchronized with the CLKA signal also becomes the first level. As a result, the CMDDEC 290 is enabled to generate the INT_CMD signal.

On the other hand, in a power-down mode, for example, when the SMP_CKE signal is at the second level (e.g., the low level), the CSGL 280 blocks the TCS signal from reaching the CMDDEC 290 by gating the TCS signal. Accordingly, even if the TCS signal is at the first level (e.g., the high level), the TCSGL signal becomes the second level (e.g., the low level), and the SMP_CS signal synchronized with the CLKA signal also becomes the second level. As a result, the CMDDEC 290 is disabled to not generate the INT_CMD signal.

In the command control circuit 2 according to the second embodiment, the TCS signal is gated using the SMP_CKE signal. Therefore, a glitch does not occur, and the CMDDEC 290 can be prevented from generating an invalid command.

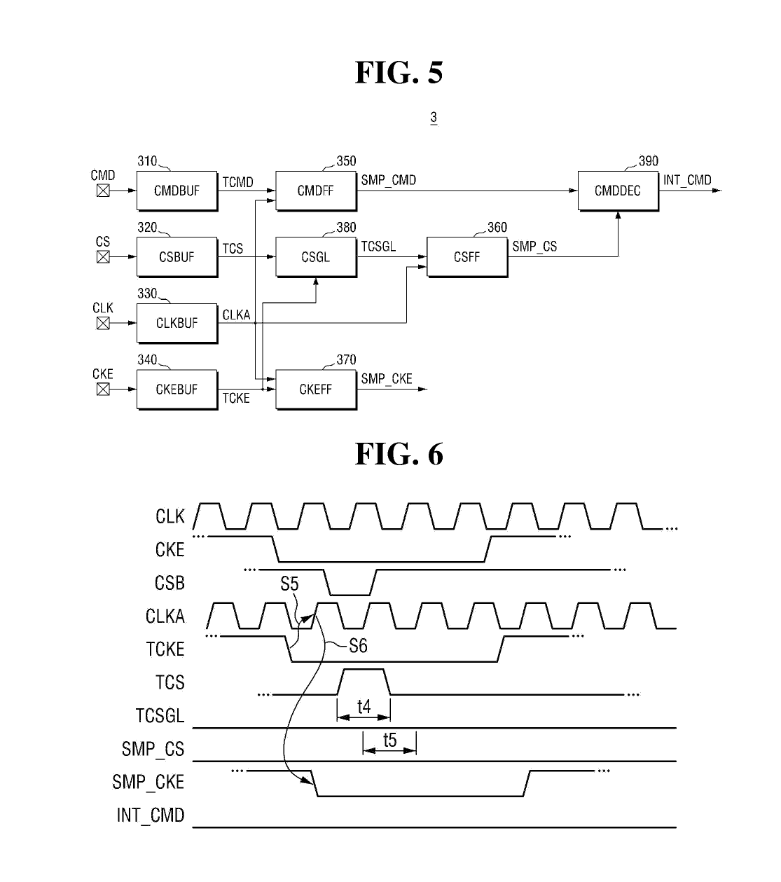

Simulation results of the command control circuit 2 shown in FIG. 3 will now be described. FIG. 4 is a schematic timing diagram illustrating changes in some signals in the command control circuit 2 of FIG. 3. In FIG. 4, a CSB signal is an inverted signal of a CS signal.

Referring to FIG. 3, a CLK signal is toggled periodically, and the CSB signal is input at a certain point in time. As a memory device enters the power-down mode, a CKE signal is maintained low for a certain period of time.

The CLKBUF 230 outputs the CLKA signal by delaying the CLK signal, and a CKEBUF 240 outputs a TCKE signal by delaying the CKE signal. The CKEFF 270 synchronizes the TCKE signal with the CLKA signal and outputs the SMP_CKE signal synchronized with the CLKA signal (s3 and s4). The CSBUF 220 outputs the TCS signal by inverting and delaying the CSB signal.

In a section of t2, the TCS signal is high, but the SMP_CKE signal is maintained low. Therefore, the TCS signal is blocked by the CSGL 280. Thus, the TCSGL signal is maintained low and is not changed. In addition, the TCSGL signal is synchronized with the CLKA signal by the CSFF 260, and, in a section of t3, the SMP_CS signal synchronized with the CLKA signal is maintained low. Therefore, the CMDDEC 290 does not generate the INT_CMD signal.

FIG. 5 is a schematic block diagram of a command control circuit 3 for a memory device according to a third embodiment. For simplicity, the following description will focus on differences from FIG. 3.

Referring to FIG. 5, in the command control circuit 3 for a memory device according to the third embodiment, a CSGL 380 gates a TCS signal received from a CSBUF 320 using a TCKE signal received from a CKEBUF 340. The CSGL 380 provides a TCSGL signal, which is a result of gating the TCS signal, to a CMDDEC 390.

In the command control circuit 3 according to the third embodiment, in a normal mode, e.g., when the TCKE signal is at a first level (e.g., a high level), the CSGL 380 provides the TCS signal to the CMDDEC 390 without gating the TCS signal. Accordingly, if the TCS signal is at the first level (e.g., the high level), the TCSGL signal becomes the first level, and a SMP_CS signal synchronized with a CLKA signal also becomes the first level. As a result, the CMDDEC 390 is enabled to generate an INT_CMD signal.

On the other hand, in a power-down mode, e.g., when the TCKE signal is at a second level (e.g., a low level), the CSGL 380 blocks the TCS signal from reaching the CMDDEC 390 by gating the TCS signal. Accordingly, even if the TCS signal is at the first level (e.g., the high level), the TCSGL signal becomes the second level (e.g., the low level), and the SMP_CS signal synchronized with the CLKA signal also becomes the second level. As a result, the CMDDEC 390 is disabled to not generate the INT_CMD signal.

In the command control circuit 3 according to the third embodiment, the TCS signal is gated using the TCKE signal. Therefore, a glitch does not occur, and the CMDDEC 390 can be prevented from generating an invalid command.

Simulation results of the command control circuit 3 shown in FIG. 5 will now be described. FIG. 6 is a schematic timing diagram illustrating changes in some signals in the command control circuit 3 of FIG. 5. In FIG. 6, a CSB signal is an inverted signal of a CS signal.

Referring to FIG. 6, a CLK signal is toggled periodically, and the CSB signal is input at a certain point in time. As a memory device enters the power-down mode, a CKE signal is maintained low for a certain period of time.

A CLKBUF 330 outputs the CLKA signal by delaying the CLK signal, and the CKEBUF 340 outputs the TCKE signal by delaying the CKE signal. The CSBUF 320 outputs the TCS signal by inverting and delaying the CSB signal.

In a section of t4, the TCS signal is high, but the TCKE signal is maintained low. Therefore, the TCS signal is blocked by the CSGL 380. Thus, the TCSGL signal is maintained low and is not changed. In addition, the TCSGL signal is synchronized with the CLKA signal by the CSFF 360, and, in a section of t5, the SMP_CS signal synchronized with the CLKA signal is maintained low. Therefore, the CMDDEC 390 does not generate the INT_CMD signal.

A CKEFF 370 synchronizes the TCKE signal with the CLKA signal and outputs a SMP_CKE signal synchronized with the CLKA (s5 and s6).

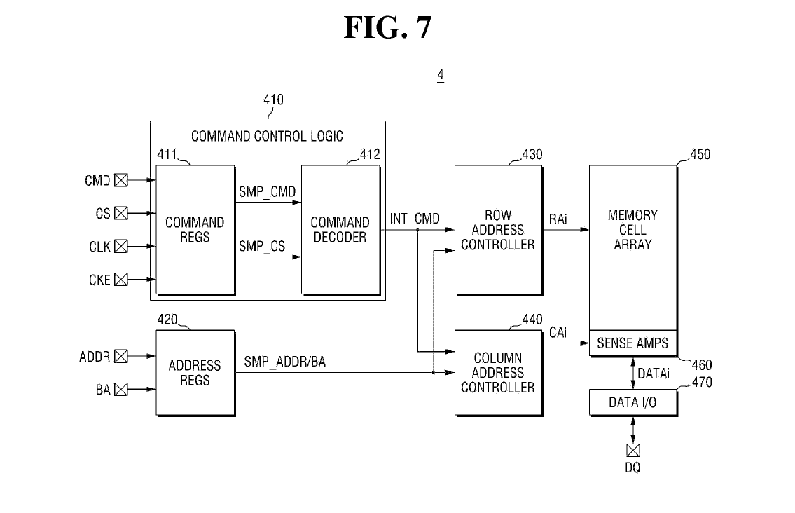

A memory device including a command control circuit according to some embodiments will now be described. FIG. 7 is a schematic block diagram of a memory device 4 including a command control circuit according to some embodiments.

Referring to FIG. 7, the memory device 4 includes a command control logic 410, an address register 420, a row address controller 430, a column address controller 440, a memory cell array 450, a sense amp 460, and a data input/output (I/O) unit 470.

The command control logic 410 is configured to generate an INT_CMD signal. The command control logic 410 may include a command register 411 and a command decoder 412. The command register 411 may receive a CMD signal, a CS signal, a CLK signal, and a CKE signal and synchronize the received signals with an internal clock signal. The command decoder 412 may receive a synchronized SMP_CMD signal and a synchronized SMP_CS signal from the command register 411 and generate the INT_CMD signal using the received signals.

Any one of the command control circuits 1 through 3 according to the above embodiments may be provided as a part of the command control logic 410.

The address register 420 receives an address (ADDR) signal and a bank address (BA) signal and synchronizes the received signals with the internal clock signal.

The row address controller 430 receives the INT_CMD signal and a synchronized address/bank address (SMP_ADDR/BA) signal and transmits a row address (RAi) signal to the memory cell array 450.

The column address controller 440 receives the INT_CMD signal and the SMP_ADDR/BA signal and transmits a column address (CAi) signal to the sense amp 460.

The memory cell array 450 includes a plurality of memory cells which store data.

The sense amp 460 reads data from a memory cell selected by the RAi signal and the CAi signal and amplifies the level of the read data. The sense amp 460 may include a write driver (not shown) and write data to a selected memory cell using the write driver.

The data I/O unit 470 may transmit or receive a data (DQ) signal to or from an external system and transmit an internal data (DATAi) signal, which is to be written to the memory cell array 450, to the sense amp 260 or receive the DATAi signal, which is read from the memory cell array 450, from the sense amp 260.

The memory device 4 described above with reference to FIG. 7 may be, but is not limited to, a DDR3 SDRAM.

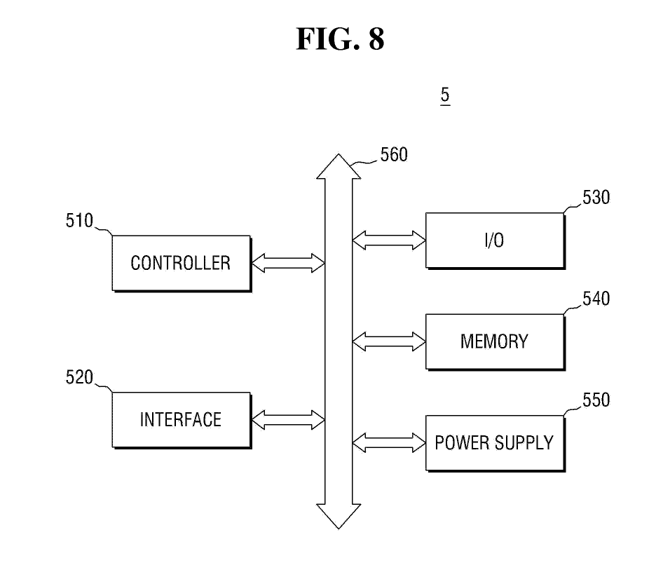

An electronic system including a memory device according to an embodiment will now be described. FIG. 8 is a schematic block diagram of an electronic system 5 including a memory device according to an embodiment.

Referring to FIG. 8, the electronic system 5 may include a controller 510, an interface 520, an I/O device 530, a memory 540, a power supply 550, and a bus 560.

The controller 510, the interface 520, the I/O device 530, the memory 540, and the power supply 550 may be coupled to each other through the bus 560. The bus 560 corresponds to a path through which data is transferred.

To process data, the controller 510 may include at least one of a microprocessor, a microcontroller, and logic devices capable of performing similar functions to those of the microprocessor and the microcontroller.

The interface 520 may transmit data to a communication network or receive data from the communication network. The interface 520 can be in a wired or wireless form. For example, the interface 520 may include an antenna or a wired/wireless transceiver.

The I/O device 530 may include a keypad and a display device to input and output data.

The memory 540 may store data and/or commands. The memory device 4 of FIG. 7 may be provided as a component of the memory 540.

The power supply 550 may convert power received from an external source and provide the converted power to the components 510 through 540.

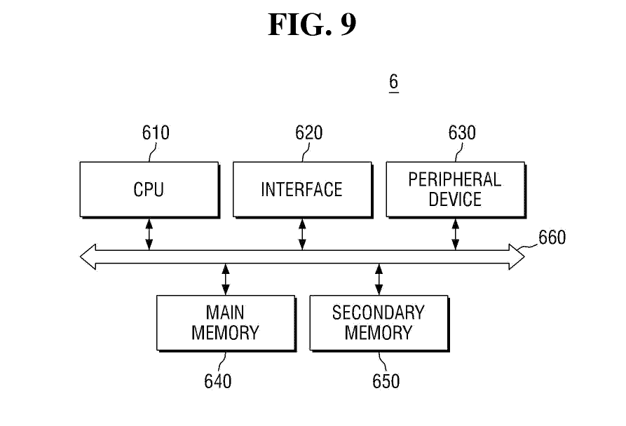

FIG. 9 is a schematic block diagram of an application example of the electronic system 5 including a memory device according to an embodiment.

Referring to FIG. 9, an electronic system 6 may include a central processing unit (CPU) 610, an interface 620, a peripheral device 630, a main memory 640, a secondary memory 650, and a bus 660.

The CPU 610, the interface 620, the peripheral device 630, the main memory 640, and the secondary memory 650 may be coupled to each other through the bus 660. The bus 660 corresponds to a path through which data is transferred.

The CPU 610 may include a control unit, an arithmetic unit, etc., to execute programs and process data.

The interface 620 may transmit data to a communication network or receive data from the communication network. The interface 620 can be in a wired or wireless form. For example, the interface 620 may include an antenna or a wired/wireless transceiver.

The peripheral device 630 may include a mouse, a keyboard, a display, and a printer to input and output data.

The main memory 640 may exchange data with the CPU 610 and store data and/or commands required for execution of programs. The memory device 4 according to the embodiment of FIG. 7 may be provided as a component of the main memory 640.

The secondary memory 650 may include a nonvolatile storage device, such as a magnetic tape, a magnetic disk, a floppy disk, a hard disk or an optical disk, and store data and/or commands. The secondary memory 650 can store data even if the power supply to the electronic system 6 is interrupted.

The memory device 4 according to the embodiment of FIG. 7 may also be provided as one of various components of an electronic device, such as a computer, an ultra-mobile PC (UMPC), a workstation, a net-book, a personal digital assistant (PDA), a portable computer, a web tablet, a wireless phone, a mobile phone, a smart phone, an e-book, a portable multimedia player (PMP), a portable game device, a navigation device, a black box, a digital camera, a three-dimensional television, a digital audio recorder, a digital audio player, a digital picture recorder, a digital picture player, a digital video recorder, a digital video player, a device capable of transmitting/receiving information in wireless environments, one of various electronic devices constituting a home network, one of various electronic devices constituting a computer network, one of various electronic devices constituting a telematics network, a radio frequency identification (RFID) device, or one of various components constituting a computing system.

In concluding the detailed description, those skilled in the art will appreciate that many variations and modifications can be made to the preferred embodiments without substantially departing from the principles of the exemplary embodiments. Therefore, the disclosed preferred embodiments are used in a generic and descriptive sense only, and not for purposes of limitation.

What is claimed is:

1. A command control circuit comprising:
a command decoder configured to generate an internal command signal using a chip select (CS) signal and a command signal; and
a CS gating logic configured to provide the CS signal to the command decoder,
wherein the CS gating logic is further configured to provide the CS signal to the command decoder in response to a clock enable (CKE) signal being at a first level, and block the CS signal from reaching the command decoder in response to the CKE signal being at a second level.

2. The circuit of claim 1, wherein the CKE signal is synchronized with an internal clock signal.

3. The circuit of claim 2, further comprising:
a CKE flip-flop configured to provide the CKE signal, which is synchronized with the internal clock signal, to the CS gating logic.

4. The circuit of claim 2, wherein the CS signal which is provided by the CS gating logic is synchronized with the internal clock signal.

5. The circuit of claim 4, further comprising:
a CS flip-flop configured to receive a CS signal, synchronize the CS signal with the internal clock signal, and provide the CS signal which is synchronized with the internal clock signal to the CS gating logic.

6. The circuit of claim 2, further comprising:
a CS flip-flop configured to be disposed between the CS gating logic and the command decoder and receive the CS signal provided by the CS gating logic, synchronize the CS signal with the internal clock signal, and provide the CS signal, which is synchronized with the internal clock signal, to the command decoder.

7. The circuit of claim 1, wherein the CKE signal is not synchronized with the internal clock signal.

8. The circuit of claim 7, further comprising:
a CS flip-flop configured to be disposed between the CS gating logic and the command decoder and receive the CS signal provided by the CS gating logic, synchronize the CS signal with the internal clock signal, and provide the CS signal, which is synchronized with the internal clock signal, to the command decoder.

9. The circuit of claim 1, further comprising:
a command flip-flop configured to provide the command signal, which is synchronized with the internal clock signal, to the command decoder.

10. A command control circuit comprising:
a command decoder configured to generate an internal command signal; and
a CS gating logic configured to gate a CS signal using a CKE signal and providing the gated CS signal to the command decoder,
wherein the command decoder is enabled in response to the gated CS signal being at a first level, and is disabled in response to the gated CS signal being at a second level.

11. The circuit of claim 10, wherein the CKE signal is synchronized with an internal clock signal.

12. The circuit of claim 11, further comprising:
a CS flip-flop configured to receive a CS signal, synchronize the CS signal with the internal clock signal, and provide the CS signal, which is synchronized with the internal clock signal, to the CS gating logic.

13. The circuit of claim 11, further comprising:
a CS flip-flop configured to be disposed between the CS gating logic and the command decoder and receive the gated CS signal, synchronize the gated CS signal with the internal clock signal, and provide the gated CS signal, which is synchronized with the internal clock signal, to the command decoder.

14. The circuit of claim 10, wherein the CKE signal is not synchronized with the internal clock signal.

15. The circuit of claim 14, further comprising:
a CS flip-flop configured to be disposed between the CS gating logic and the command decoder and receive the gated CS signal, synchronize the gated CS signal with the internal clock signal, and provide the gated CS signal, which is synchronized with the internal clock signal, to the command decoder.

16. A method of a command control circuit, the method comprising:
receiving a chip select (CS) signal, a command signal, and a clock enable (CKE) signal;
generating an internal command signal based on the CS signal and the command signal in response to the CKE signal being at a first level; and
blocking the internal command signal from being generated in response to the CKE signal being at a second level.

17. The method of claim 16, wherein the first level is the high level and the second level is the low level.

18. The method of claim 17, wherein the high level is a normal mode and the low level is a power-down mode.

19. The method of claim 16, wherein the CKE signal is synchronized with an internal clock signal.

20. The method of claim 16, wherein the CKE signal is not synchronized with an internal clock signal.
